(19) United States
(12) Patent Application Publication
(10) Pub. No.: US 2010/0252580 A1
(43) Pub. Date: Oct. 7, 2010

(54) Automatic C.A.R.C. waterborne or water based paint and/or coating batch mixing apparatus

(75) Inventor: Jon Bredbenner, Hanover, PA (US)

Correspondence Address: David Crompton, 1220 Fish Road, Tiverton, RI, 02878, US

(73) Assignee: C.H. Reed Inc., Hanover, PA (US)

(21) Appl. No.: 11/626,062

(22) Filed: Jan. 23, 2007

(51) Int. Cl. B65D 88/54; B67D 7/74; G01G 17/04; B67D 7/82

(52) U.S. Cl. 222/318; 222/1; 222/77; 222/135; 222/146.2

(57) ABSTRACT

An automated apparatus, recipe based C.A.R.C. paint batch mixing system and method for mixing two or more water based or waterborne chemical agent resistant coating materials, primarily designed to meet military specification number MIL-DTL-64159. Once homogeneously dispensed and mixed in the desired recipe quantity, the operator removes the batch mixed material and applies the material to a substrate using various types of application methods. The complete apparatus is designed as a modular configuration, allowing for a reduced footprint and quick assembly.

The invention consists of an automated batch dispense apparatus, recipe based C.A.R.C. paint batch mixing system and method for mixing two or more water based or waterborne chemical agent resistant coating (C.A.R.C.) materials, primarily designed to meet military specification number MIL-DTL-64159.

The automated waterborne or water based C.A.R.C. batch mixing apparatus employs a process and equipment that provides the user with an interface to create and select pre-formulated recipes of the C.A.R.C. material; select a dispense amount between 1 quart and 5 gallons; then receive a precise ratio of multiple component liquid or powdered materials into the dispense container. The C.A.R.C. automated Batch Mixing Apparatus employs a fluid circulation process that controls the fluid viscosity, flow rate, speed, and circulation at the time of dispense. This fluid circulation process maintains proper suspension of the waterborne or water based C.A.R.C. components, delivering highly accurate mixing results, generally + or −2% accuracy to the user recipe. Further the C.A.R.C. batch mixing apparatus contains features which allow the user the ability to make calculated manual adjustments to the dispense recipe.

The advantages of this invention are the elimination of hand mixing; the ability to dispense measured C.A.R.C. materials in any quantity from 1 quart to 5 gallons; proper mixing through controlled fluid velocity and circulation for a higher accuracy of mixing; the ability to create and dispense previously saved fluid recipes; and mixed fluid viscosity control through electronic fluid heating.

### INVENTION BACKGROUND

Material suppliers have developed a new generation of waterborne CARC coatings for use in the defense and military industry. MIL-DTL-64159 Type II Waterborne CARC is a two-component waterborne polyurethane coating offering superior exterior durability compared to previous CARC coatings, lower Volatile Organic Compounds (VOC's) (1.8 pounds per gallon) and a long wet edge that eliminates dry spray. In addition, the coating provides superior film build, using up to 30% less coating resulting in material savings.

MIL-DTL-64159 Type II Waterborne CARC has less odor and is compatible with electrostatic spray applications. It is non-flammable and provides a durable, flexible finish with longer exterior durability when compared to other CARC coatings. MIL-DTL-64159 Type II Waterborne CARC meets the strict requirements of the U.S. armed forces and is listed on the Qualified Products List (Q.P.L.) published by the Army Research Lab.

As noted above, C.A.R.C. is a multiple component, waterborne or water based Chemical Agent Resistant Coating primarily applied to the surface of a military vehicle, aircraft, or weapon's substrate, as a required by Military specification MIL-DTL-64159. Prior to the new apparatus, the C.A.R.C. paint or coatings were manually mixed, using pre-measured kits referred to as “kitting”. This process often caused the user to manually pre-mix larger amounts of waterborne or water based C.A.R.C. material than required for the substrate. This caused significant waste as unused material was often discarded. In addition, waterborne or water based C.A.R.C. paint or coatings require vigorous and continuous mixing throughout the mixing process to ensure proper dispersion of the material solids during the batch mixing process.

### INVENTION DISCLOSURE

The purpose of this invention is a method and apparatus for the automation of the manual batch dispense of C.A.R.C. paints and coatings. The prior process included the combining of pre-formulated materials in pre-measured containers, a process known as kitting. The major disadvantages of kitting have historically been the higher cost over bulk supply methods, rapid curing once the material is per-mixed and the inability to mix materials in smaller or preset amounts. These factors have often caused kitting to be a high cost method of C.A.R.C. application.

The invention is designed to automatically circulate and dispense batch recipes of a mixed C.A.R.C. material in both the amount dispensed and ratio. Through the dispense process, the speed of circulation, flow rate and the velocity of the materials are precisely controlled to maintain suspension of the material solids and ensure proper homogeneous mixing of the accurately dispensed amount of C.A.R.C. and at a mix ratio which is consistent with the mix ration accuracy requirements of military specification MIL-DTL-64159.

The advantage of this apparatus over any somewhat similar design would be its ability to maintain suspension of the C.A.R.C. fluid components independently, which ensures proper dispensing and mixing at pre-determined amounts. Suspension is maintained through controlled circulation, velocity, pressure and flow of the specific C.A.R.C. material component. In addition to its accurate ratio and dispense, the C.A.R.C. batch mixing system features the ability to report on the user, quantity dispensed, dispense ratio accuracy, material and inventory usage.

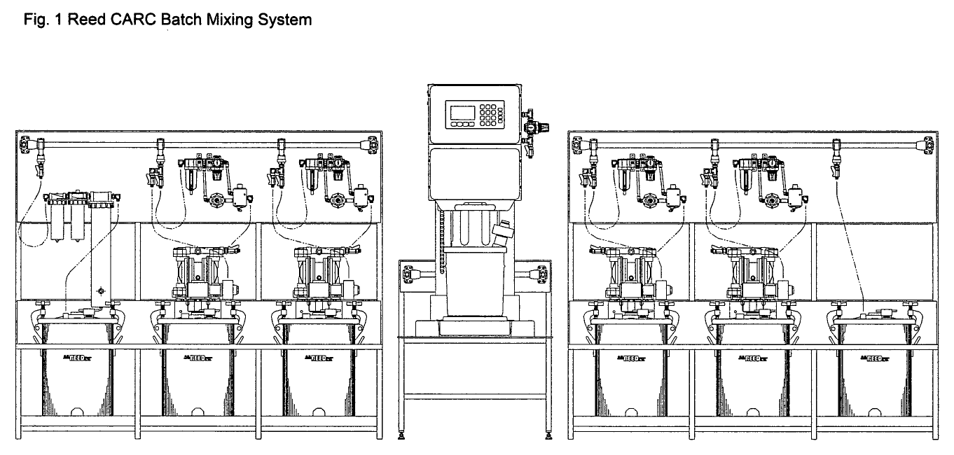

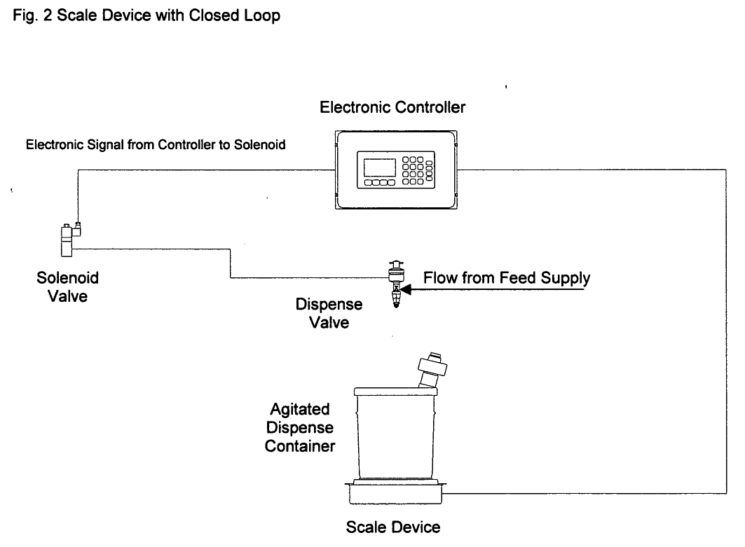

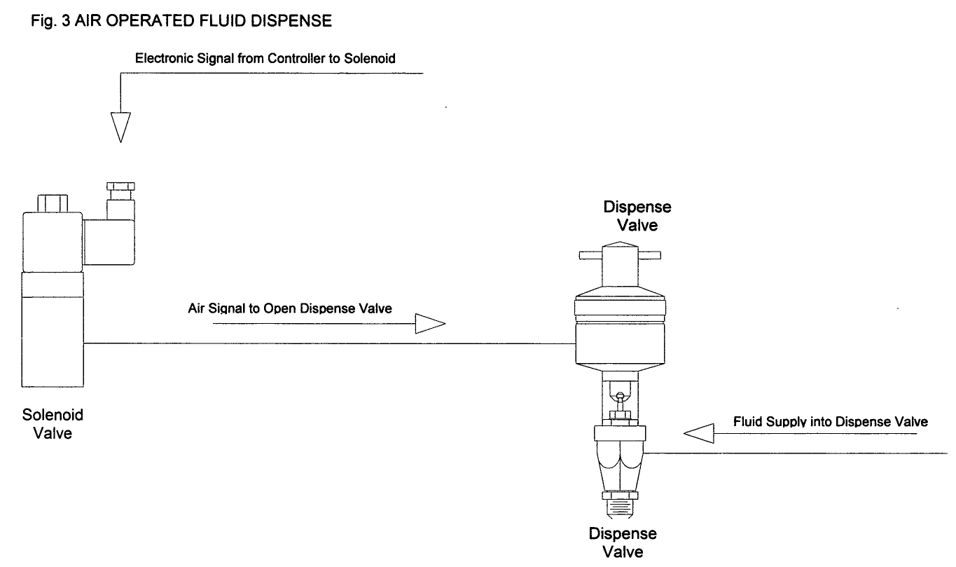

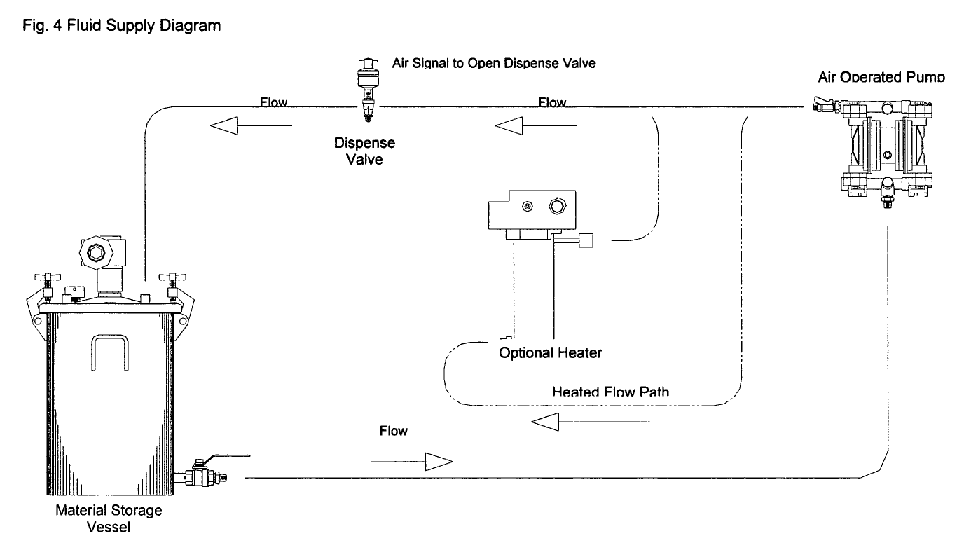

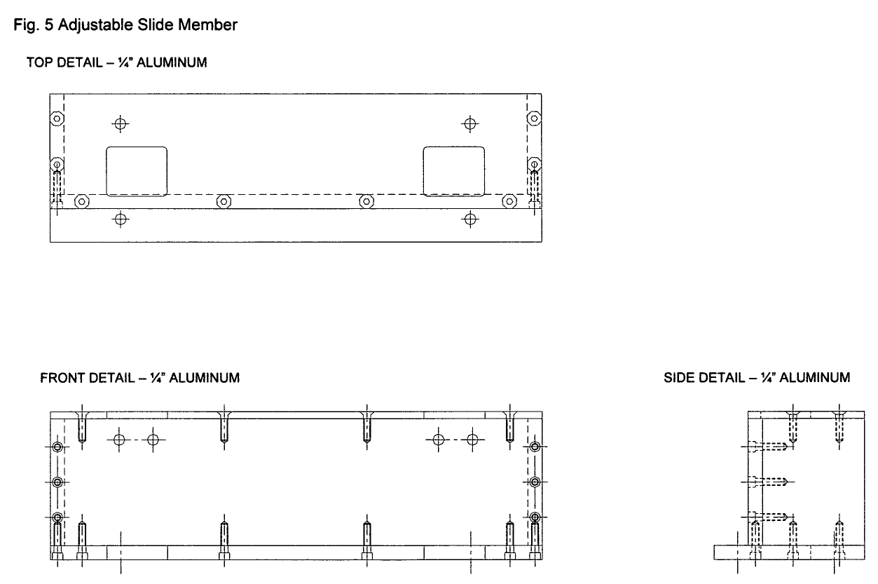

The mixing apparatus includes a material feed system, consisting of bottom outlet; circulated, agitated, heated or ambient temperature vessels, fed to the dispense valves using air operated transfer pumps (FIG. 1). The fluid velocity and circulation are precisely controlled and continuously circulated in their separate containers; then fed through ambient or heated fluid lines to electronically actuated fluid dispense valves (FIG. 3). The electronically actuated dispense valves are controlled through a recipe based controller (FIG. 3), which opens the dispense valves to dispense pre-selected recipe amounts of the fluid to be dispensed (FIG. 4). Exact dispense amounts are calculated using self-calibrating electronically controlled scale devices, with closed loop feedback to the system controller (FIG. 2). The speed and amount of the dispensed material is precisely controlled using weight based mathematical formula calculations, processed through the batch mixing system controller. The height between the scale device and the apparatus dispense valves is adjusted to meet the elevation requirements of containers sized from one quart to 5 gallons, using an adjustable slide member (FIG. 5).

Once homogeneously dispensed and mixed in the desired recipe quantity, the operator removes the batch mixed material and applies the material to a substrate using various types of application methods.

The complete apparatus is designed as a modular configuration, allowing for a reduced footprint and quick assembly (FIG. 1).

### BRIEF DESCRIPTION OF DRAWINGS

(1) C.A.R.C. modular based batch mixing apparatus designed to accurately measure, mix and dispense chemical agent resistant coatings. This modular assembly can be modified to batch C.A.R.C. coatings utilizing two or more fluid components, accurately dispensing in containers from one quart to five gallons.

(2) Self-calibrating scale device with closed-loop communication to the apparatus controller. The closed loop sends an electronic signal to signify the progression of dispense. As the dispensed amount moves near the targeted recipe requirement, the controller slows the velocity and flow of the dispensed rate to increase the recipe ratio accuracy.

(3) The apparatus deploys electronically actuated fluid dispense valves which are automatically opened by communication loop through the fluid controller. Fluid is circulated through the dispense valve to maintain viscosity, suspension and temperature. The dispensed C.A.R.C. fluid components may be heated to maintain the fluid viscosity; then pumped through a circulation loop to the electrically actuated, air operated fluid dispense valves.

(4) The material feed fluid supply system circulates through fluid supply vessels in a continuous loop through in-line heaters; regulation and the fluid dispense valves. The apparatus is configured using air-operated pumps to maintain the fluid velocity, temperature and proper mixing characteristics.

(5) The C.A.R.C. batch mixing apparatus controller is mounted on an adjustable slide member, which allows for the elevation or reduction in height. The adjustable slide member accommodates smaller containers to one quart; and all container sizes through five gallons. The adjustable slide member is designed with pre-configured stop points that safely lock the member into its new position.

1. An automated waterborne or water based C.A.R.C. (Chemical Agent Resistant Coating) paint and/or coating batch mixing apparatus consisting of a process and equipment that provides the user/operator with an interface to create, select and dispense pre-formulated recipes of a C.A.R.C. material.

2. An automated C.A.R.C. dispense method which comprises an apparatus for dispensing pre-measured recipe mixtures of material components using selectable control, dispensing amounts between 1 quart and 5 gallons.

3. An apparatus which is comprised of mechanically controlled valves delivering precisely controlled ratios of multiple component liquid and/or powdered materials into a dispense container.

4. A C.A.R.C. batch mixing apparatus consisting of a weight based scale device which precisely measures the dispensed fluid, dispense accuracy and amount of the C.A.R.C. material.

5. A C.A.R.C. batch mixing apparatus including a process controller providing closed loop on the dispense time, fluid amount and ratio accuracy, which is collected to an integrated process controller and associated reporting database.

6. An automated C.A.R.C. batch mixing apparatus consisting of a fluid circulation process that controls the fluid viscosity, speed, flow rate and circulation at the time of dispense. This fluid circulation process maintains proper suspension of the waterborne or water based C.A.R.C. components.

7. An apparatus for the automatic batch mixing of Military specification MIL-DTL-64159 C.A.R.C. coatings or paints.

8. An electronically heated C.A.R.C. batch mixing apparatus consisting of fluid heaters that increase the material temperature, reduce viscosity and control the dispense temperature of a mixed C.A.R.C. waterborne or water based material.

9. A C.A.R.C. bulk circulated feed supply system consisting essentially of up to 6 material supply vessels from 1 gallon to 300 gallons in size.

10. A C.A.R.C. batch mixing apparatus consisting of a controller that is mounted on an adjustable slide member. The adjustable slide member allows for the elevation or reduction in height of the dispense valve assembly.
